(19) United States
(12) Patent Application Publication
(10) Pub. No.: US 2010/0128665 A1
(43) Pub. Date: May 27, 2010

(54) Method for providing signaling between a core network and a radio access network

(75) Inventor: Colin Kahn, Morris Plains, NJ (US)

Correspondence Address: HARNESS, DICKEY & PIERCE, P.L.C., P.O. BOX 8910, RESTON, VA, 20195, US

(73) Assignee: ALCATEL-LUCENT USA INC.

(21) Appl. No.: 12/292,570

(22) Filed: Nov. 21, 2008

(51) Int. Cl. H04W 40/00

(52) U.S. Cl. 370/328

(57) ABSTRACT

Example embodiments provide methods for providing signaling between a core network and a radio access network (RAN). One example embodiment includes receiving an IP packet at the core network; inserting information into a destination options extension header of the IP packet at the core network; and sending the IP packet from the core network to the RAN. Another example embodiment includes receiving an IP packet at the RAN from the core network; extracting information from a destination options extension header of the IP packet at the RAN; and sending the IP packet from the RAN to a terminal.

### BACKGROUND OF THE INVENTION

1. Field

Example embodiments of the present invention relate generally to wireless systems and signaling between different components in a wireless system.

2. Description of the Related Art

Wireless systems may provide wireless communication for terminals or mobile devices connected to the wireless systems. A wireless system may include a core network and a radio access network (RAN). The core network includes components which provide functionality such as call routing, charging for used services, and authentication for users requesting services from the service provider associated operating the core network.

The radio access network (RAN) may be disposed between the core network and the terminal or mobile device. The RAN may provide a path for flows of data sent between the core network and the terminal or mobile device. The RAN may include multiple base stations connected to the core network through, for example, a controller. The RAN may implement an air interface for handling a radio-based communication link between the base stations and the terminal or mobile device. In order to manage data flows flowing from the core network, through the RAN to the terminal or mobile device, it may be necessary for components in the core network to transmit information regarding the data flows to components in the RAN.

### SUMMARY OF THE INVENTION

The present invention relates to methods of providing a signaling mechanism between components in a core network and components in a RAN by using the destination options extension header supported by IP packets like, for example, those following the IPv6 protocol.

In one embodiment, an IP packet is received at the core network. Information is then inserted into a destination options extension header of the IP packet at the core network, and the IP packet is sent from the core network to a RAN.

In another embodiment, a RAN receives an IP packet from a core network. Information is then extracted from a destination options extension header of the IP packet at the RAN, and the IP packet is sent from the RAN to a terminal.

### BRIEF DESCRIPTION OF THE DRAWINGS

Example embodiments of the present invention will become more fully understood from the detailed description provided below and the accompanying drawings, wherein like elements are represented by like reference numerals, which are given by way of illustration only and thus are not limiting of the present invention and wherein:

FIG. 1 is a diagram illustrating a wireless system including a core network and radio access network (RAN).

FIG. 2A illustrates a diagram of an IPv6 packet.

FIG. 2B illustrates a diagram of an IPv6 packet including a destination options extension header.

FIG. 3 is a flow chart illustrating an exemplary method of handling the transmission of packet-specific information from a core-network to an RAN.

FIG. 4 is a flow chart illustrating an exemplary method of handling the receipt of packet-specific information from a core network at a RAN.

### DETAILED DESCRIPTION OF EXAMPLE EMBODIMENTS

Various example embodiments of the present invention will now be described more fully with reference to the accompanying drawings in which some example embodiments of the invention are shown.

Detailed illustrative embodiments of the present invention are disclosed herein. However, specific structural and functional details disclosed herein are merely representative for purposes of describing example embodiments of the present invention. This invention may, however, may be embodied in many alternate forms and should not be construed as limited to only the embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the invention to the particular forms disclosed, but on the contrary, example embodiments of the invention are to cover all modifications, equivalents, and alternatives falling within the scope of the invention. Like numbers refer to like elements throughout the description of the figures. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

As used herein, the term “terminal” may be considered synonymous to, and may hereafter be occasionally referred to, as a mobile unit, mobile station, mobile user, user equipment (UE), subscriber, user, remote station, access terminal, receiver, etc., and may describe a remote user of wireless resources in a wireless communication network. The term “base station” may be considered synonymous to and/or referred to as a base transceiver station (BTS), NodeB, extended Node B, femto cell, access point, etc. and may describe equipment that provides the radio baseband functions for data and/or voice connectivity between a network and one or more users.

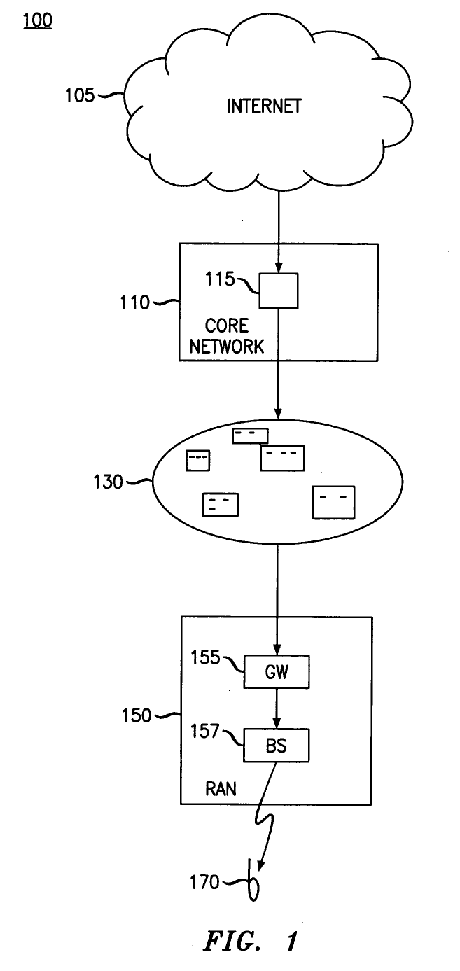

FIG. 1 illustrates a wireless system 100 according to an example embodiment. Referring to FIG. 1, wireless system 100 may include a core network 110, routers 130, an RAN 150, and a terminal 170.

The core network 110 receives IP traffic from, for example, the internet 105. The core network is connected to the RAN 150 via routers 130. The RAN 150 is in wireless communication with the mobile 170.

The core network 110 may follow one of a number of protocols including LTE, WiMax and EV-DO.

Though not pictured, the core network 110 may include protocol specific core network components, for example, a Public Data Network (PDN) for a core network following the LTE or EV-DO protocols, or a connectivity service network (CSN) for a core network following the WiMax protocol. The core network 110 includes a packet analyzer 115 for analyzing incoming IP traffic. Packet analyzer 115 may be any device which can analyze incoming IP packets and collect data relating to the IP packets or IP packet flows of which the IP packets may be part. For example, the packet analyzer 115 may be a deep packet inspection (DPI) component. The core network 110 is connected to routers 130.

The routers 130 include a plurality of interconnected routers for receiving and forwarding IP packets.

The RAN 150 includes a gateway 155 and at least one base station 157. The RAN may follow one of a number of protocols including LTE, WiMax and EV-DO. The type of gateway 155 and base station 157 included in RAN 150 may depend on the protocol of the RAN 150. For example, if RAN 150 follows the LTE protocol, gateway 155 may be a packet data network gateway (P-GW) or a serving gateway (SGW) and base station 157 may be an enodeB. If RAN 150 follows the WiMax protocol, gateway 155 may be an access service network gateway (ASN-GW). If RAN 150 follows the EV-DO protocol, gateway 155 may be a packet data serving node (PDSN) or a high rate packet data serving gateway (HSGW). Though gateway 155 is illustrated as being connected to one base station 157, gateway 155 may be connected to any number of base stations.

Wireless system 100 may handle IP traffic which includes IP packets following the IPv6 protocol. The wireless system may handle IP traffic following alternative protocols that support at least one extension header.

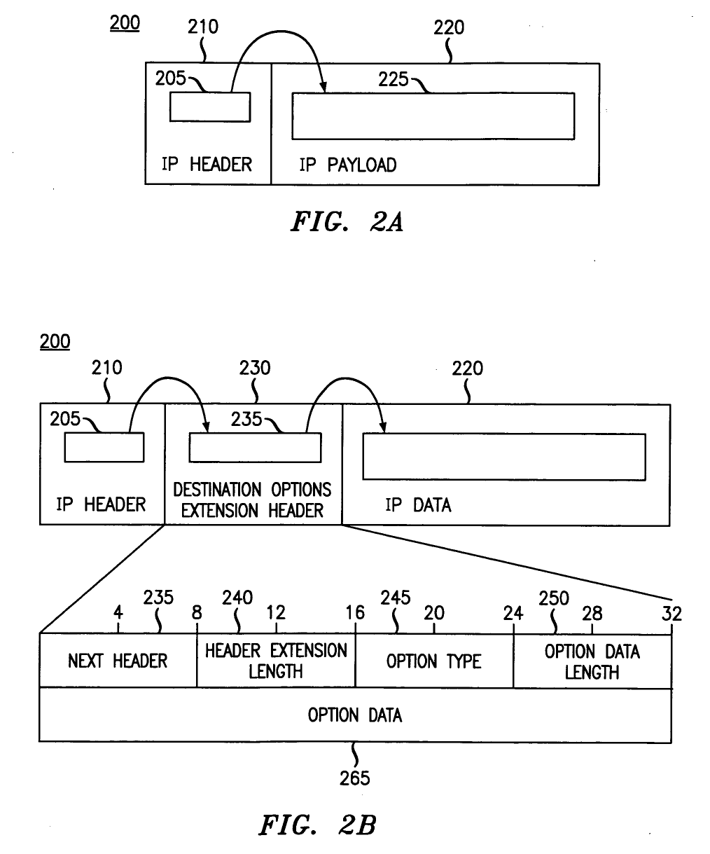

IP packets, in particular IPV6 packets, will now be discussed with reference to FIGS. 2A and 2B.

FIG. 2A illustrates a diagram of an IP packet 200 including an IP header 210 and an IP payload 220. IP header 210 may include information necessary for the proper processing and delivery of IP packet 200 such as, a source address, destination address, and version type of the IP packet. IP header 210 may also include a next header field 205. Next header field 205 may a number pointing to a following portion of IP packet 200. Referring to FIG. 2A, next header field 205 includes a number associated with data inside the IP payload 220. Accordingly, the IP header 210 may be linked to the IP payload 220 through next header field 205. The IP payload 220 may include IP data 225 being carried by IP packet 200. For example, IP Data 225 may be a higher-level packet such as a TCP packet.

The IPv6 protocol supports extension headers. Other IP protocols may also support extension headers. Extension headers are supplementary headers which may be included in IP packets in addition to the IP header to provide added flexibility. IPv6 specifies multiple types of extension headers. One such type is the destination options extension header which may be generally used to store information that is to be used at the ultimate destination of an IP packet.

FIG. 2B illustrates a diagram of an IP packet 200 including a destination options extension header 230. Referring to FIG. 2B, the next header field 205 of the IP header 210 may include a number corresponding to the destination options extension header 230. Accordingly, the IP header 210 may be linked to the destination options extension header 230 through next header field 205. The destination options extension header 230 may include a next header field 235, a header extension length field 240, an option type field 245, an option data length field 250, and an option data field 265.

Next header field 235 is a one byte field and may be used similar to next header field 205. Referring to FIG. 2B, the next header field 235 includes a number corresponding to the IP payload 220. The header extension length field 240 is a one byte field that indicates the length of the extension header 230. The option type field 245 is a one byte field indicating an option type associated with destination option extension header 230. The option data length field 250 is a one byte field indicating a length of the data being sent in the destination option extension header 230. The option data field 265 is a field of variable length which stores the data being sent in the destination option extension header 230. Field sizes in other IP protocols may vary from those of IPv6.

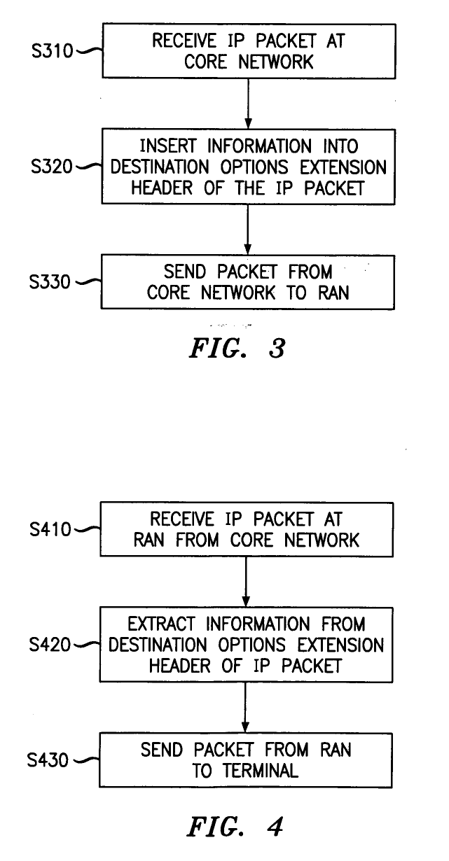

A method for handling signaling between a core network and a RAN according to an example embodiment will now be explained with reference to FIGS. 1 and 3.

FIG. 3 is a flow chart illustrating a method of handling the transmission of proprietary information from a core-network to a RAN.

In step S310, the core network 110 receives an IP packet from, for example, the internet 105.

The received IP packet follows an IP protocol and supports extension headers. In one embodiment, the received IP packet follows the IPv6 protocol and supports destination option extension headers. The IP packet may be part of an IP packet flow including a plurality of IP packets.

The received IP packet is analyzed by the packet analyzer 115, which collects information corresponding to the IP packet.

For example, the packet analyzer 115 may collect information relating to an application, application type and/or content provider associated with the received IP packet and/or an IP packet flow of which the received IP packet is a part.

The packet analyzer 115 may collect information relating to a specific type of data in the received IP packet. For example, the packet analyzer 115 may determine that the received IP packet is part of an MPEG video IP packet flow and the data analyzer 115 may determine whether the IP packet carries MPEG video I-frame or P-frame data. The packet analyzer 115 may also determine the received IP packet is part of an enhanced variable rate codec (EVRC) IP packet flow and the packet analyzer may determine whether the IP packet carries ⅛ rate frame or full frame data.

The packet analyzer 115 may collect information relating to a protocol associated with the received IP packet. For example, the packet analyzer 115 may determine the received IP packet is part of a UDP or TCP/IP packet flow.

The packet analyzer 115 may collect information relating to an encryption state of the IP packet. For example, the packet analyzer 115 may determine the IP packet is part of an encrypted IP packet flow.

The packet analyzer 115 may collect information relating to a user associated with the IP packet. For example, the packet analyzer 115 may determine the IP packet is part of an application packet flow. The packet analyzer 115 may then determine whether the application packet flow corresponds to an application being used by a business-class user or a standard user. The packet analyzer 115 may also determine whether or not the received IP packet is part of an application flow being sent from a content-provider with whom a service provider operating the core network 10 and the RAN 150 has a business relationship.

In step S320, proprietary information is inserted into a destination options extension header of the IP packet.

It is to be understood that the term “proprietary information” as used herein may refer to any data a service provider operating a core network chooses to insert into the destination options extension header of an IP packet.

The packet analyzer 115 may insert the proprietary information into the destination options extension header of the IP packet, or the proprietary information may be inserted into the destination options extension header of the IP packet by another component in the core network 10.

The proprietary information is based on the information collected by the packet analyzer 115 in step S310.

In one embodiment, the inserted proprietary information is the information collected by the packet analyzer 115 in step S310. For example, the packet analyzer 115 may be configured to determine the packet type of the received IP packet, and the proprietary information inserted into the destination option extension header of the received IP packet may be a tag identifying the type of data being carried by the IP packet. For example, the inserted tag may identify the data being carried by the received IP packet as one of, for example, MPEG-video I-frame data, MPEG-video P-frame data, EVRC ⅛ rate frame data, EVRC full frame data, UDP data, TCP data, encrypted data or data associated with a preferred user or content-provider.

In another embodiment, the inserted proprietary information is information selected from a source other than the packet analyzer 115, based on the information collected by the packet analyzer 115 in step S310. For example, the core network 110 may be connected to an external database which stores the MPEG-related data in a particular entry of the database. The core network 110 may be configured to access the external database and insert data from MPEG-related database entry into the destination options extension header of the received IP packet whenever the packet analyzer 115 determines the received IP packet contains MPEG data. Likewise, the core network 110 may be configured to access an external database and insert data from a database entry relating one of, for example, EVRC data, UDP data, TCP data, data being used by preferred users, or data being provided by preferred content-providers, whenever the packet analyzer 115 determines the IP packet contains data corresponding to one of those data types.

In step S330, the core network 110 sends the IP packet to the RAN 150. The core network 110 may send the IP packets, including the proprietary information, to the RAN 150 through routers 130 which may exist between the core network 110 and RAN 150. Because the proprietary information is located inside the destination option extension header of the IP packet, the routers 130 used to forward the IP packet from the core network 110 to the RAN 150 will ignore the information inside the destination option extension header of the IP packet. Accordingly, the IP packet will travel through the routers 130 in the same manner as an IP packet that is not carrying proprietary information.

A method for handling signaling between a core network and a RAN according to an example embodiment will now be explained with reference to FIGS. 1 and 4.

FIG. 4 is a flow chart illustrating a method of handling the receipt of proprietary information from a core network at a RAN.

In step S410, the RAN 115 receives an IP packet sent by the core network 110. The IP packet includes a destination options extension header storing proprietary information. The IP packet may be received by the gateway 155.

In step S420, proprietary information is extracted from the destination options extension header of the IP packet.

In one embodiment, in step S420, the proprietary information is extracted from the IP packet by the gateway 155. The gateway 155 then uses the extracted proprietary information to prioritize the IP packet and returns the IP packet to the state the IP packet was in before the proprietary information was inserted into the IP packet. The gateway 155 then forwards the IP packet to the base station 157. Examples of prioritizing the IP packet will be discussed below.

In another example embodiment, in step S420, the gateway 155 extracts the proprietary information from the IP packet. The gateway 155 then returns the IP packet to the state the IP packet was in before the proprietary information was inserted into the IP packet. Instead of acting on the extracted proprietary information at the gateway 155, the gateway 155 may then forward the IP packet and the extracted proprietary information to the base station 157. Alternatively, instead of forwarding that actual extracted proprietary information, the gateway 155 may forward information based on the extracted proprietary information to the gateway 155. The base station 157 may then prioritize the IP packet based on the information received from the gateway 155.

In yet another example embodiment, in step S420, the gateway 155 may not extract the proprietary information from the IP packet. Instead, the gateway may forward the IP packet to the base station 157, with the base station 157 extracting the proprietary information from the IP packet and prioritizing the IP packet based on the extracted proprietary information.

Examples of using the extracted proprietary data to prioritize IP packets will now be discussed. Though, in the examples below, the IP packets are explained as being prioritized by the gateway 155, it will be understood that, depending on the embodiment, the IP packets may also be prioritized by the base station 157.

As one example, the gateway 155 may prioritize IP packets in flows determined to be associated with business users over IP packets in flows determined to be associated with standard users. Similarly, content-providers like, for example CNN, who have entered into a business arrangement with a system operator operating core network 110 and RAN 150 may be treated as preferred content-providers. The gateway 155 may prioritize IP packets in flows determined to be associated with preferred content-providers. Accordingly, higher quality service may be given to IP packets associated with users or content providers who pay for preferential treatment.

As another example, the gateway 155 may use proprietary information extracted from IP packets in an IP packet flow associated with a streaming MPEG video to determine whether each IP packet in the IP packet flow contains MPEG I-frame or MPEG P-frame data. If the gateway 155 experiences congestion and is required to drop packets, the gateway 155 may use the extracted proprietary data to drop packets containing MPEG P-frame data before dropping packets containing MPEG I-frame data because I-frame data is more important to the quality of a video associated with the MPEG stream experienced by a subscriber viewing the MPEG video.

Similarly, when receiving an IP packet flow corresponding to EVRC data, if the gateway 155 is experiencing congestion, the gateway 155 may choose between dropping IP packets containing ⅛ frame data and IP packets containing full rate data based on quality goals of a subscriber.

As yet another example, the gateway 155 may receive IP packets associated with a UDP flow and IP packets associated with a TCP flow. Because dropped TCP packets generally result in greater delays for an application flow than dropped UDP packets, the gateway 155 may choose to drop IP packets associated with UDP flows before dropping IP packets associated with TCP flows.

Returning to FIG. 3, in step S430, the IP packet is sent from the base station 157 to the terminal 170 based on, for example, one of the above priority determinations. Because the IP packet was returned to the state the IP packet was in prior to the insertion of the proprietary data, the terminal 170 will not detect that proprietary information was added to the received IP packet prior to receipt at the terminal 170.

Methods for handling signaling between a core network and a RAN according to example embodiments allow components in a core network to send information to components in an RAN by using, an extension header found in IP packets, for example the destination options extension header found in IP packets following the IPv6 protocol, as a signaling mechanism. Accordingly, the RAN may have access to information that may usually be encapsulated in higher level packets than the RAN normally has access to, and the RAN may use that information to make decisions about how to process IP packets.

All of the functions described above with respect to the method are readily carried out by special or general purpose digital information processing devices acting under appropriate instructions embodied, e.g., in software, firmware, or hardware programming. For example, modules implementing the functionality an be implemented as an ASIC (Application Specific Integrated Circuit) constructed with semiconductor technology and may also be implemented with FPGA (Field Programmable Gate Arrays) or any other hardware blocks.

The invention being thus described, it will be obvious that the same may be varied in many ways. Such variations are not to be regarded as a departure from the invention, and all such modifications are intended to be included within the scope of the invention.

What is claimed:

1. A method of signaling between a core network and a radio access network (RAN), the method including:
receiving an IP packet at the core network;
at the core network, inserting information for processing of the IP packet at the RAN into a destination options extension header of the IP packet; and
sending the IP packet including the destination options extension header from the core network to the RAN.

2. The method of claim 1 wherein the IP packet follows the IPv6 protocol.

3. The method of claim 1 wherein the received IP packet is part of an IP packet flow being received at the core network, the method further comprising:
analyzing the IP packet flow at the core network,
wherein the information inserted into the destination options extension header of the IP packet is one of information based on the analysis of the IP packet flow, and information selected from a source based on the analysis of the IP packet flow.

4. The method of claim 3 wherein the analysis of the IP packet flow, on which the information inserted into the destination options extension header of the IP packet is based, is performed by a deep packet inspection (DPI) device in the core network.

5. The method of claim 4 wherein the information inserted into the destination options extension header of the IP packet is inserted by the DPI device.

6. The method in claim 1 wherein the received IP packet is part of an IP packet flow being received at the core network, and wherein, the information inserted into the destination options extension header of the IP packet includes information corresponding to one of an application, application type, and content provider associated with the IP packet flow.

7. A method of signaling between a core network and a radio access network (RAN), the method including:
receiving an IP packet at the RAN from the core network;
extracting information from a destination options extension header of the IP packet at the RAN; and
sending a corresponding IP packet without the destination options extension header that was extracted from the RAN to a terminal.

8. The method of claim 7 wherein the received IP packet follows the IPv6 protocol.

9. The method of claim 7 further comprising:
removing the destination options extension header from the received IP packet before sending the corresponding IP packet from the RAN to the terminal.

10. The method of claim 7 wherein the received IP packet is part of an IP packet flow being received at the RAN, and wherein the information extracted from the destination options extension header of the received IP packet is based on an analysis of the received IP packet flow.

11. The method of claim 10 wherein, the information extracted from the destination options extension header of the received IP packet includes information corresponding to one of an application, application type, user, and content provider associated with the received IP packet flow.

12. The method of claim 10 further comprising:
deciding how to allocate resources with respect to the received IP packet based on the extracted information.

13. The method of claim 12 wherein the deciding includes determining a priority level for forwarding the received IP packet to the terminal, with respect to other IP packets, based on the extracted information.

14. The method of claim 7 wherein, the RAN follows an LTE protocol and the extracted information is extracted from the destination options extension header of the received IP packet at a packet data network gateway (P-GW) or a serving gateway (SGW) inside the RAN.

15. The method of claim 7 wherein, the RAN follows a WiMax protocol and the extracted information is extracted from the destination options extension header of the received IP packet at an access service network gate way (ASN-GW) inside the RAN.

16. The method of claim 7 wherein, the RAN follows an EV-DO protocol and the extracted information is extracted from the destination options extension header of the received IP packet at one of a packet data serving node (PDSN) inside the RAN, and a high rate packet data serving gateway (HSGW) inside the RAN.

17. The method of claim 7 wherein, the extracted information is extracted from the destination options extension header of the received IP packet at one of an enodeB inside the RAN, and a base station (BS) inside the RAN.

18. The method of claim 7 wherein the sending of the IP packet is prioritized based on the information extracted from the destination options extension header.

19. A method comprising:
receiving an IP packet at a radio access network (RAN), the IP packet including an extension header identifiable as having information for an ultimate destination;
extracting the information from the extension header of the IP packet at the RAN; and
forwarding a corresponding IP packet without the extension header that was extracted at the RAN to the ultimate destination.

20. The method of claim 19 wherein the forwarding of a corresponding IP packet comprises:
prioritizing the corresponding IP packet based on the information extracted from the extension header.
